(19) United States
(12) Patent Application Publication
(10) Pub. No.: US 2018/0300146 A1
(43) Pub. Date: Oct. 18, 2018

(54) DATABASE OPERATING METHOD AND APPARATUS

(71) Applicant: Alibaba Group Holding Limited, Grand Cayman (KY)

(72) Inventor: Jingyu Wang, Zhejiang (CN)

(21) Appl. No.: 16/013,812

(22) Filed: Jun. 20, 2018

Related U.S. Application Data
(63) Continuation of application No. PCT/CN2016/109653, filed on Dec. 13, 2016.

(30) Foreign Application Priority Data
Dec. 21, 2015 (CN) 201510960860.4

(51) Int. Cl. G06F 9/38; G06F 17/30; G06F 9/46

(52) U.S. Cl. CPC G06F 9/3842; G06F 9/466; G06F 17/30368; G06F 17/30371

(57) ABSTRACT

A method including executing a trigger instruction of a target transaction according to a user instruction, and acquiring a service logic code into which the target transaction is encapsulated; conducting a speculative execution of the target transaction according to the service logic code, and recording a segmentation condition and an involved data range of the target transaction that are obtained in the process of the speculative execution; and controlling a database to which the segmentation condition is directed to conduct an actual execution of the target transaction according to the service logic code as well as the segmentation condition and the involved data range of the target transaction that are obtained in the process of the speculative execution, when the speculative execution succeeds. The method improves the transaction execution efficiency and increases the transaction throughput.

### CROSS REFERENCE TO RELATED PATENT APPLICATIONS

This application claims priority to and is a continuation of PCT Patent Application No. PCT/CN2016/109653, filed on 13 Dec. 2016, which claims priority to Chinese Patent Application No. 201510960860.4, filed on 21 Dec. 2015 and entitled “DATABASE OPERATING METHOD AND APPARATUS”, which are incorporated herein by reference in their entirety.

### TECHNICAL FIELD

The present disclosure relates to the field of database technologies, and, more particularly, to database operating methods and apparatuses.

### BACKGROUND

A database transaction refers to a series of operations executed as a single logical unit of work, which is either executed completely or not executed at all. One transaction is composed of a series of database operating instructions, such as Structured Query Language (SQL) statements. There are segmentation conditions and logic such as jump between the database operating instructions, which means that some of the database operating instructions in the transaction may be skipped in one execution procedure. However, in the conventional techniques, it is impossible to learn information such as segmentation conditions or jump logic of a transaction in advance. Therefore, the determination has to be made according to execution logic during the execution of the transaction, and statements in the transaction are executed in sequence to implement operations on the database. Such a transaction execution manner is inefficient and has low transaction throughput.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides database operating methods and apparatuses, to improve the transaction execution efficiency and increase the transaction throughput.

In an aspect, the present disclosure provides a database operating method including:

executing a trigger instruction of a target transaction according to a user instruction, and acquiring a service logic code into which the target transaction is encapsulated;

speculatively executing the target transaction according to the service logic code, and recording a segmentation condition and an involved data range of the target transaction that are obtained in the process of the speculative execution; and

controlling a database to which the segmentation condition is directed to actually execute the target transaction according to the service logic code as well as the segmentation condition and the involved data range of the target transaction that are obtained in the process of the speculative execution, when the speculative execution succeeds.

In another aspect, the present disclosure provides a database operating apparatus including:

an acquisition module configured to execute a trigger instruction of a target transaction according to a user instruction, and acquire a service logic code into which the target transaction is encapsulated;

a speculative execution module configured to speculatively execute the target transaction according to the service logic code, and record a segmentation condition and an involved data range of the target transaction that are obtained in the process of the speculative execution; and

an execution control module configured to control a database to which the segmentation condition is directed to actually execute the target transaction according to the service logic code as well as the segmentation condition and the involved data range of the target transaction that are obtained in the process of the speculative execution, when the speculative execution succeeds.

In the present disclosure, a database operating apparatus obtains, according to a trigger instruction of a user, a service logic code into which a target transaction is encapsulated; speculatively executes the target transaction according to the service logic code, speculates a segmentation condition and an involved data range of the target transaction; and controls a database to which the segmentation condition is directed to actually execute the target transaction according to the service logic code as well as the target transaction of the target transaction and the involved data range that are obtained in the process of the speculative execution, when the speculative execution succeeds. The segmentation condition of the target transaction may be obtained through speculative execution, and a database or databases on which the target transaction should be executed may be determined, ensuring the certainty of database consumption. On one hand, the techniques of the present disclosure determine in advance whether the target transaction is a stand-alone transaction or a distributed transaction; on the other hand, data may be prepared in advance, thus helping improve the transaction execution efficiency and further increasing the transaction throughput.

### BRIEF DESCRIPTION OF THE DRAWINGS

In order to illustrate the technical solutions in the example embodiments of the present disclosure more clearly, accompanying drawings required for describing the example embodiments or the conventional techniques are briefly outlined below. Apparently, the accompanying drawings in the following description only depict some of the example embodiments of the present disclosure, and for those of ordinary skill in the art, other drawings may be derived from these accompanying drawings without creative efforts.

FIG. 1 is a deployment diagram of a database application system in the conventional techniques;

FIG. 2 is a deployment diagram of a database application system according to an example embodiment of the present disclosure;

FIG. 3 is a schematic flowchart of a database operating method according to an example embodiment of the present disclosure; and

FIG. 4 is a schematic structural diagram of a database operating apparatus according to an example embodiment of the present disclosure.

### DETAILED DESCRIPTION

To make the technical solutions and advantages of the example embodiments of the present disclosure clearer, the technical solutions in the example embodiments of the present disclosure will be described below with reference to the accompanying drawings in the example embodiments of the present disclosure. It is apparent that the example embodiments described merely represent some examples embodiments rather than all of the embodiments of the present disclosure. Based on the example embodiments in the present disclosure, all other example embodiments obtained by those of ordinary skill in the art without creative efforts should belong to the protection scope of the present disclosure.

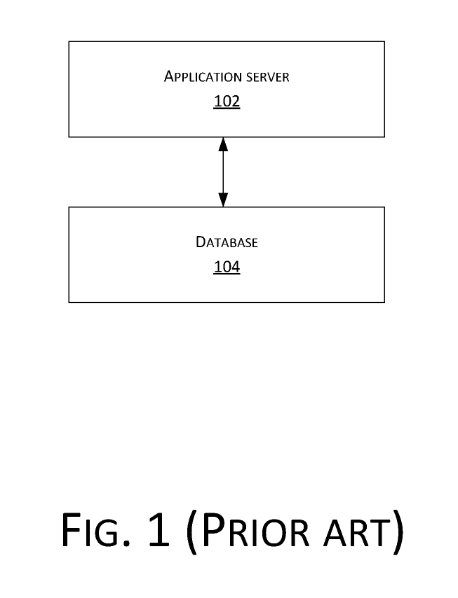

FIG. 1 is a deployment diagram of a database application system according to the conventional techniques. As shown in FIG. 1, the system includes an application server 102 and a database 104. There may be one or more application servers 10. There may also be one or more databases 20. FIG. 1 shows only one application server 102 and one database 104 as an example. When the database 104 needs to be accessed by means of a transaction, the application server 102 executes the transaction logic, and applies database operating instructions in the transaction to the database 104 in sequence. Such a transaction execution manner is inefficient and has low transaction throughput.

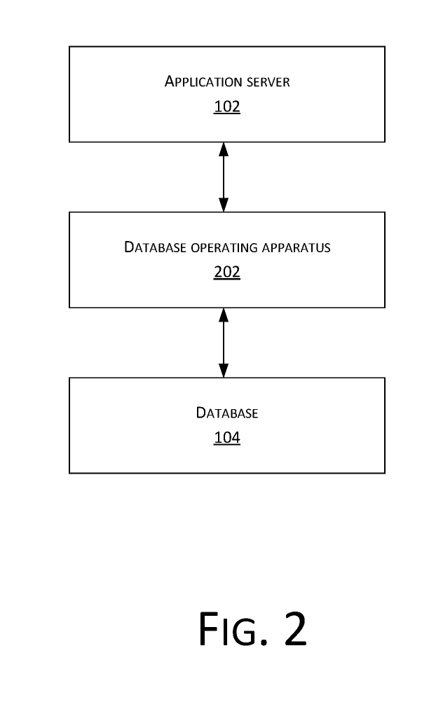

In view of the defects in the conventional techniques, the present disclosure provides a novel database application system, as shown in FIG. 2. In this system, a database operating apparatus 202 is added between the application server 102 and the database 104. The database operating apparatus 202 is configured to execute the database operating method provided by the present disclosure, to realize a new type of transaction execution logic, i.e., speculatively executing a target transaction based on a service logic code into which the target transaction is encapsulated, and then controlling the database 104 to actually execute the target transaction according to the service logic code into which the target transaction is encapsulated as well as a segmentation condition and an involved data range of the target transaction that are obtained in the process of the speculative execution.

The present disclosure may obtain the segmentation condition of the target transaction through speculative execution, and may determine a database or databases on which the target transaction should be executed, thereby ensuring the certainty of database consumption. On one hand, whether the transaction is a stand-alone transaction or a distributed transaction is determined in advance; on the other hand, data may be prepared in advance, thus helping improve the transaction execution efficiency and further increasing the transaction throughput. In addition, the present disclosure combines speculative execution with the service logic code. The service logic code includes execution logic of the target transaction. Therefore, the database does not need to be concerned about changes in a shared data set (i.e., data in the database). Serial and correct execution of the transaction may be ensured as long as the segmentation condition and the involved data range of the target transaction do not change, so that the rollback probability of the transaction may be reduced. The transaction throughput refers to the number of transactions processed per unit time.

It should be noted that the database operating apparatus 202 is actually a logic processing apparatus, which may be deployed alone and located between the application server 102 and the database 104, or may be deployed on the application server 102 for implementation or deployed on the database 104 for implementation.

The method process of the technical solution in the present disclosure will be described in detail in the following example embodiments.

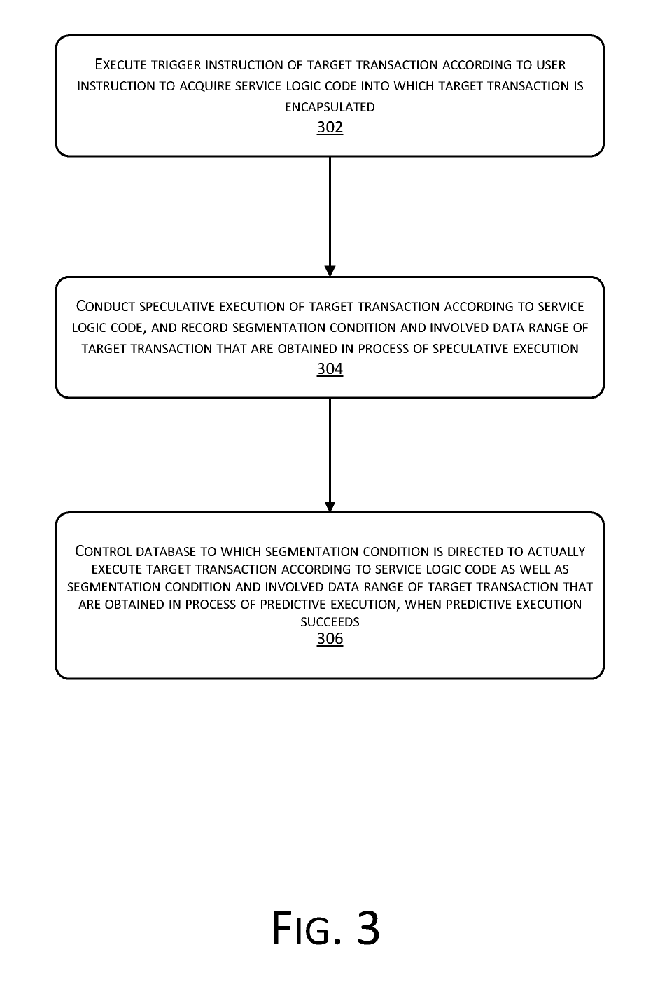

FIG. 3 is a schematic flowchart of a database operating method according to an example embodiment of the present disclosure. As shown in FIG. 3, the method includes the following steps:

302: A trigger instruction of a target transaction is executed according to a user instruction, to acquire a service logic code into which the target transaction is encapsulated.

304: The target transaction is speculatively executed according to the service logic code, and a segmentation condition and an involved data range of the target transaction that are obtained in the process of the speculative execution are recorded.

306: A database to which the segmentation condition is directed is controlled to actually execute the target transaction according to the service logic code as well as the segmentation condition and the involved data range of the target transaction that are obtained in the process of the speculative execution, when the speculative execution succeeds.

It should be noted first that for ease of description, a transaction that a user needs to execute is referred to as a target transaction in this example embodiment. The target transaction mainly includes instructions for operating the database. In addition to the database operating instructions, the target transaction further includes some control instructions for controlling execution states of the target transaction, for example, a transaction start instruction, a transaction commit instruction, a transaction rollback instruction, and so on. The instructions are actually statements written in a database language. Depending upon different database languages, the instructions may be statements written in different languages. For example, if SQL is adopted, the foregoing database operating instruction and control instructions are actually a series of SQL statements.

In this example embodiment, the target transaction needs to be encapsulated into a service logic code. The database operating instructions in the target transaction and information such as a jump condition and logic between database operating instructions are encapsulated in the service logic code. That is, in the process of the speculative execution and the process of actual execution, the execution logic of the entire target transaction is controlled by the database operating apparatus and the database respectively.

The service logic code needs to be deployed on the database operating apparatus and each database in advance, and is pre-compiled. In actual use of the service logic code, a name of the service logic code is only needed to provide once. Compared with constant transmission of database operating instructions, this method helps reduce network traffic and save network resources. Optionally, if the service logic code further requires input parameters, the required input parameters may also be provided in addition to the name of the service logic code. For example, the user may provide the name of the service logic code to the database operating apparatus by using a trigger instruction, and the database operating apparatus may acquire the service logic code according to the name.

Optionally, the service logic code may be a storage procedure, or may be implemented in other manners. If the service logic code is a storage procedure, the execution speed is higher because all statements in the storage procedure have been compiled. In use, only the name of the storage procedure and necessary parameters need to be transmitted, thereby consuming only a small amount of network traffic.

An inventory reduction transaction is used as an example below. SQL codes of the inventory reduction transaction are as follows, and words in brackets are annotations:

```
    begin transaction (the transaction begins)
    select*from inventory where itemId=?for update (the current
inventory is checked by using an item id, and is locked)
    if(item.inventory>0)
    item.inventory--;
    update inventory set item.inventory=$item.inventory where itemId=?
    commit;
    else
    rollback; (if the current inventory is greater than 0, the item inventory
is reduced, updated and committed; otherwise, the transaction is rolled
back)
```

The inventory reduction transaction may be encapsulated into a procedure, and the procedure may be named buySth(long itemId). The procedure returns true/false to indicate whether the inventory reduction transaction succeeds. Pseudocodes of the procedure are as follows:

procedure:
boolean buySth(long itemId){
Item item=executeQuery(“select*from inventory where itemId=?for
update”);
if(item.inventory>0){
item.inventory--;
executeUpdate(update inventory set item.inventory=$item.inventory
where itemId=?)
commit( );
return true;
}else{
rollback( );
return false;
}

As shown from the above that the foregoing storage procedure into which the inventory reduction transaction is encapsulated includes database operating instructions in the inventory reduction transaction, some instructions of the storage procedure itself, and also service logic of the inventory reduction transaction.

For example, when needing to execute the target transaction, the user may send a trigger instruction to instruct execution of the target transaction. The database operating apparatus acquires, according to the trigger instruction of the user, the service logic code into which the target transaction is encapsulated. Optionally, the trigger instruction may include a name of the service logic code, or there is a mapping relationship between the trigger instruction and the name of the service logic code. In total, the database operating apparatus may acquire, according to the trigger instruction, the service logic code into which the target transaction is encapsulated.

After acquiring the service logic code, the database operating apparatus may speculatively execute the target transaction according to the service logic code, and record a segmentation condition and an involved data range of the target transaction that are obtained in the process of the speculative execution. The segmentation condition of the target transaction is used for indicating which database or databases are related to the target transaction. For example, the segmentation condition of the target transaction may be denoted by such information as a partition key (PartitionKey). That is, the determination of a list of PartitionKeys in the process of the speculative execution of the target transaction is equivalent to the determination of the segmentation condition of the target transaction. The involved data range of the target transaction is used for indicating which piece or pieces of data in the database, to which the segmentation condition is directed, is/are, for example, related to the target transaction. For example, data related to the target transaction may be denoted by such information as primary keys (PrimaryKeys) of the data. That is, the determination of a list of PrimaryKeys in the process of the speculative execution of the target transaction is equivalent to the determination of the involved data range of the target transaction.

The process of the database operating apparatus speculatively executing the target transaction according to the service logic code is actually: running an instruction in the service logic code, and when the instruction is a database operating instruction in the target transaction encapsulated in the service logic code, speculatively executing the database operating instruction to implement speculative execution of the target transaction. In the process of speculatively executing the database operating instruction in the run target transaction, the database operating apparatus may determine, according to the result of the speculative execution, a next database operating instruction that needs to be executed.

Operations performed by the database operating instructions on the database are mainly for accessing data in the database. Therefore, a data environment of the database operating instruction may be simulated, and the database operating instruction is speculatively executed based on the simulated data environment. On this basis, the database operating instruction may be speculatively executed in the following manner: simulating a data environment of the database operating instruction in a locally created memory library, and speculatively executing the database operating instruction based on the simulated data environment.

Further, an implementation of simulating a data environment of the database operating instruction in a locally created memory library, and speculatively executing the database operating instruction based on the simulated data environment includes the following steps:

The acquired database operating instruction is split into a read instruction and a write instruction; the read instruction is run on the real database, that is, the read instruction is executed in the database to acquire a read data set (ReadSet). The read data set is stored into a local memory library, to simulate a data environment required for the database operating instruction. Then, the write instruction is applied to the memory library, to realize speculative execution of the database operating instruction, that is, the write instruction is executed in the memory library to modify the read data set. For example, relevant data in the read data set is updated, queried, or otherwise processed. A resultant data set (affectRowInMemdb) may be generated after the write instruction is executed to modify the read data set.

In the foregoing process of the speculative execution, each time the database operating apparatus speculatively executes a database operating instruction, PrimaryKeys and PartitionKey in the read data set read by the database operating instruction are recorded locally. Optionally, the database operating apparatus may also record the entire read data set and the resultant data set including information such as a version number corresponding to the primary key, but the present disclosure is not limited thereto.

PrimaryKeys in the read data set reflects an involved data range of the target transaction, and PartitionKey in the read data set reflects a database or databases to which the data involved in the target transaction is distributed, and therefore may be used as a segmentation condition of the target transaction.

The database operating apparatus continues to run the service logic code. When the apparatus proceeds to a transaction commit instruction (such as the foregoing commit( ) in the target transaction included in the service logic code, “true” may be returned, indicating that the speculative execution succeeds. On the contrary, if the apparatus proceeds to a transaction rollback instruction (such as the foregoing rollback( ) in the target transaction included in the service logic code, “false” may be returned, indicating that the speculative execution fails.

The database operating apparatus may control the database to which the segmentation condition of the target transaction acquired in the process of the speculative execution is directed to actually execute the target transaction according to the service logic code as well as the segmentation condition and the involved data range of the target transaction that are obtained in the process of the speculative execution, when the speculative execution succeeds.

In an implementation, the database operating apparatus may issue a name of the service logic code to the database to instruct the database to run the service logic code to actually execute the target transaction, and may receive a segmentation condition and an involved data range of the target transaction that are obtained in the process of actual execution and returned by the database. If the segmentation condition and the involved data range of the target transaction that are obtained in the process of actual execution are both the same as the segmentation condition and the involved data range of the target transaction that are obtained in the speculative execution, the database operating apparatus may issue a transaction commit instruction to the database, for the database to commit the target transaction. If at least one of the segmentation condition and the involved data range of the target transaction that are obtained in the process of actual execution is different from the segmentation condition and the involved data range of the target transaction that are obtained in the speculative execution, the database operating apparatus may issue a transaction rollback instruction to the database, for the database to roll back the target transaction.

In another implementation, the database operating apparatus may issue a name of the service logic code as well as the segmentation condition and the involved data range of the target transaction that are obtained in the process of the speculative execution to the database to instruct the database to run the service logic code to actually execute the target transaction, and commit the target transaction when a segmentation condition and an involved data range of the target transaction that are obtained in the process of actual execution are both the same as the segmentation condition and the involved data range of the target transaction that are obtained in the speculative execution, or roll back the target transaction when at least one of the segmentation condition and the involved data range of the target transaction that are obtained in the process of actual execution is different from the segmentation condition and the involved data range of the target transaction that are obtained in the speculative execution

Optionally, in order to reduce the number of interactions between the database operating apparatus and the database and save network resources, the name of the service logic code as well as the segmentation condition and the involved data range of the target transaction that are obtained in the process of the speculative execution may be issued to the database simultaneously (together).

Compared with a pure procedure solution, the present disclosure adds a process of the speculative execution, so that the segmentation condition and the involved data range of the target transaction may be obtained in advance, and a database or databases on which the target transaction should be executed may be determined.

On one hand, based on the speculated segmentation condition of the target transaction, whether the target transaction is a stand-alone transaction or a distributed transaction is determined in advance. If the target transaction is determined as a stand-alone transaction, the database may be controlled to actually execute the target transaction according to stand-alone transaction processing logic. If the target transaction is determined as a distributed transaction, the database may be controlled to actually execute the target transaction according to distributed transaction processing logic. The distributed transaction processing logic and the stand-alone transaction processing logic are different. The stand-alone transaction processing logic is relatively simple, for example, it does not involve issues such as read/write locking, and therefore fewer resources are consumed. On this basis, by identifying whether the target transaction is a stand-alone transaction and processing the target transaction according to the stand-alone transaction processing logic when the target transaction is identified as a stand-alone transaction, this example embodiment helps improve processing efficiency, increase transaction throughput, and reduce processing costs.

On the other hand, data may be prepared in advance based on the speculated segmentation condition and involved data range of the target transaction. For example, all cross-node data is pre-loaded from a “lower-level disk storage” of other databases or the local database, thereby helping improve the transaction execution efficiency and further increasing the transaction throughput.

In addition, the present disclosure provides a pure speculative execution solution, which mainly refers to a speculative execution solution in which an application server controls execution logic of the target transaction. In this solution, in the process of executing the target transaction by the application server, database operating instructions of the target transaction that the application server proceeds to are acquired in sequence. The database operating instruction is speculatively executed, and the speculative execution result is returned to the application server, so that the application server may determine a database operating instruction that needs to be executed, and locally record the database operating instruction and speculative execution data generated during the speculative execution. When a transaction commit instruction in the target transaction is acquired, a database corresponding to the application server is controlled to actually execute the target transaction according to the locally recorded database operating instruction and the speculative execution data. The method of controlling the database corresponding to the application server to actually execute the target transaction may include: issuing the locally recorded database operating instruction to the database to instruct the database to execute the database operating instruction; if the actual execution result is the same as the speculative execution result, committing the target transaction; and if the actual execution result is different from the speculative execution result, rolling back the target transaction.

Transactions are concurrent in the process of the speculative execution, and are sequentially executed in series during actual execution in the database. Therefore, two transactions operating the same data may be correct in the speculative execution stage. However, in the actual execution stage, whichever transaction is executed first, the other transaction will be rolled back because the speculative execution result is different from the actual execution result as the data has changed, resulting in a high rollback probability.

For example, it is assumed that there are two transactions: transaction 1 and transaction 2, and both transactions are reading the value of key and assigning the value to id. If id=0, id is incremented by 1 and id+1 is used as a new value of key. In the process of the speculative execution, because values in the database are not changed, both transactions may read key=0 and assign the value to id; moreover, because id=0, the second statement may be executed successfully, that is, id is incremented by 1 and id+1 is assigned to key, i.e., speculative execution results of both transactions are key=1. However, in the process of actual execution, the two transactions need to be executed in series. It is assumed that transaction 1 is performed first and then transaction 2 is performed. In this case, transaction 1 may read id=0, increment id by 1 and assign id+1 to key so that key=1. When transaction 2 is executed, key=1 is read and the value is assigned to id so that id=1, and then id is incremented by 1 and id+1 is assigned to key so that key=2. By comparing the actual execution results with the speculative execution results of the two transactions, the actual execution result and the speculative execution result of transaction 2 are different, and therefore transaction 2 needs to be rolled back. However, in fact, if the database may obtain the service logic of transaction 2, the second statement does not need to be executed when id>0, that is, it is unnecessary to execute the operation of incrementing id by 1 and assigning id+1 to key. In this case, the obtained execution result is still key=1, so that transaction 2 does not need to be rolled back.

Compared with the pure speculative execution solution, the present disclosure adds the procedure solution and makes full use of the advantages of the procedure solution. The database may acquire service logic of the target transaction in the process of actual execution and execute the target transaction according to the service logic of the target transaction. Therefore, the database does not need to be concerned about changes in a shared data set (i.e., data in the database). Serial and correct execution of the transaction may be ensured as long as the segmentation condition and the involved data range of the target transaction do not change, which may solve the rollback phenomenon in the pure speculative execution solution to some extent, thus helping reduce the rollback probability and improve the transaction execution efficiency.

The foregoing inventory reduction transaction is still used as an example in the following, to illustrate the working procedure of the technical solution of the present disclosure in detail.

SQL codes of the inventory reduction transaction are described as above, and pseudocodes of a procedure into which the inventory reduction transaction is encapsulated are also described as above.

In a process of actual execution, a database operating apparatus (or referred to as an execution server) acquires the foregoing procedure according to a trigger instruction of a user, and then runs the procedure.

First, the database operating apparatus creates a memory library locally.

When proceeding to the SQL statement: select*from inventory where itemId=?for update, the database operating apparatus directly searches for the SQL statement in the database, records the result of this query (that is, to-be-processed data that is found, i.e., the current inventory quantity) in the local memory library, and at the same time records PrimaryKeys and PartitionKey involved in this query.

It should be noted that the SQL statement is a query statement; therefore, the result remains unchanged whether the statement is split or not. To simplify the operation, the query statement may not be split.

The database operating apparatus determines whether the query result is greater than 0. If yes, the database operating apparatus reduces the current inventory quantity, and executes an update statement, that is, update inventory set item.inventory=$item.inventory where itemId=?; if no, the database operating apparatus rolls back the statement.

If proceeding to a rollback statement, the database operating apparatus clears the local memory library. In this case, because the transaction is not executed in the database, the database does not need to execute a rollback operation.

If proceeding to an update statement, i.e., update inventory set item.inventory=?where itemId=?, the database operating apparatus splits the SQL statement into a database read instruction, i.e., select*from inventory where itemId=?, and a database write instruction, i.e., update inventory set item.inventory=? where itemId=?. Then, the database operating apparatus issues the statement select*from inventory where itemId=? to the database, to obtain a read data set, and writes data in the read data set to the local memory library. Next, the database operating apparatus performs an update operation in the local memory library according to the statement update inventory set item.inventory=?where itemId=?, to obtain a resultant data set, and at the same time, records PrimaryKeys in the read resultant set and corresponding version number information, and records PartitionKey.

After executing a commit instruction, the database operating apparatus returns a value “true”, and executes all the aforementioned instructions together with the transaction again in a lower-level database (this execution is actual execution).

After finishing the foregoing procedure, the database operating apparatus will obtain the following transaction execution template:

invoked procedure:
boolean buySth(long itemId)
corresponding parameter: itemId=xxx
corresponding PartitionKey list=xxx.

Further, in the foregoing process of executing the procedure, PrimaryKeys in ReadSet and its corresponding version number information may further be recorded. This helps pre-load all cross-node data from other “lower-level databases” and “lower-level disk storages” of a local database according to the recorded PrimaryKeys before execution in the lower-level database. The manner of pre-loading cross-node data may load data in low-speed devices to memory in batches, play an important role in sequential execution of the procedure, and significantly improve the execution efficiency.

It should be noted that the foregoing method example embodiments are all expressed as a series of action combinations for ease of description. However, those skilled in the art should know that the present disclosure is not limited by the described action sequence, because some steps may be performed in other sequences or simultaneously according to the present disclosure. Secondly, those skilled in the art should also know that the embodiments described in the specification are example, and the actions and modules involved are not mandatory to the present disclosure.

In the foregoing example embodiments, the description of each example embodiment has its own focus. For content that is not detailed in one example embodiment, reference may be made to the relevant description of another example embodiment.

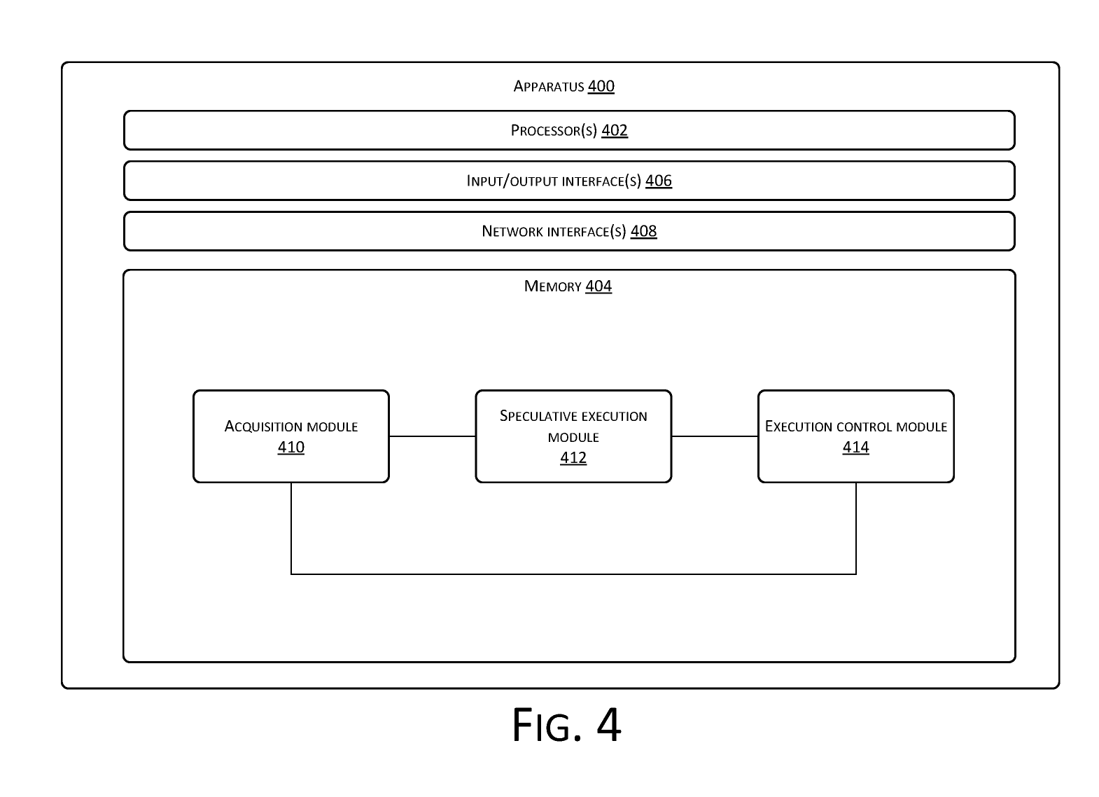

FIG. 4 is a schematic structural diagram of a database operating apparatus according to an example embodiment of the present disclosure. As shown in FIG. 4, an apparatus 400 includes one or more processor(s) 402 or data processing unit(s) and memory 404. The apparatus 400 may further include one or more input/output interface(s) 406 and one or more network interface(s) 408. The memory 404 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 404 may store therein a plurality of modules or units including an acquisition module 410, a speculative execution module 412, and an execution control module 414.

The acquisition module 410 is configured to execute a trigger instruction of a target transaction according to a user instruction, and acquire a service logic code into which the target transaction is encapsulated.

The speculative execution module 412 is configured to speculatively execute the target transaction according to the service logic code acquired by the acquisition module 410, and record a segmentation condition and an involved data range of the target transaction that are obtained in the process of the speculative execution.

The execution control module 414 is configured to, when the speculative execution performed by the speculative execution module 412 succeeds, control a database to which the segmentation condition is directed to actually execute the target transaction according to the service logic code as well as the segmentation condition and the involved data range of the target transaction that are obtained in the process of the speculative execution.

In an optional implementation, the speculative execution module 412 is configured to:

run an instruction in the service logic code; and

when the instruction is a database operating instruction in the target transaction encapsulated in the service logic code, speculatively execute the database operating instruction.

Further, when speculatively executing the run database operating instruction, the speculative execution module 412 is, for example, configured to:

if the database operating instruction is a database modification instruction, simulate a data environment of the database operating instruction in a locally created memory library, and speculatively execute the database operating instruction based on the simulated data environment; and

if the database operating instruction is not a database modification instruction, execute the database operating instruction in the database to speculatively execute the database operating instruction.

Furthermore, when simulating a data environment of the database operating instruction in a locally created memory library, and speculatively executing the database operating instruction based on the simulated data environment, the speculative execution module 412 is, for example, configured to:

split the database operating instruction into a read instruction and a write instruction;

execute the read instruction in the database to acquire a read data set, and store the read data set into the memory library to simulate the data environment of the database operating instruction; and

execute the write instruction in the memory library to modify the read data set.

In an optional implementation, the execution control module 414 is, for example, configured to:

issue a name of the service logic code to the database to instruct the database to run the service logic code to actually execute the target transaction, and receive a segmentation condition and an involved data range of the target transaction that are obtained in the process of actual execution and returned by the database;

issue a transaction commit instruction to the database for the database to commit the target transaction if the segmentation condition and the involved data range of the target transaction that are obtained in the process of actual execution are both the same as the segmentation condition and the involved data range of the target transaction that are obtained in the speculative execution; and

issue a transaction rollback instruction to the database for the database to roll back the target transaction if at least one of the segmentation condition and the involved data range of the target transaction that are obtained in the process of actual execution is different from the segmentation condition and the involved data range of the target transaction that are obtained in the speculative execution.

In another optional implementation, the execution control module 414 may be configured to:

issue a name of the service logic code as well as the segmentation condition and the involved data range of the target transaction that are obtained in the process of the speculative execution to the database to instruct the database to run the service logic code to actually execute the target transaction, and commit the target transaction when a segmentation condition and an involved data range of the target transaction that are obtained in the process of actual execution are both the same as the segmentation condition and the involved data range of the target transaction that are obtained in the speculative execution, or roll back the target transaction when at least one of the segmentation condition and the involved data range of the target transaction that are obtained in the process of actual execution is different from the segmentation condition and the involved data range of the target transaction that are obtained in the speculative execution.

Further, the execution control module 414 may be, for example, configured to:

issue the name of the service logic code as well as the segmentation condition and the involved data range of the target transaction that are obtained in the process of the speculative execution to the database simultaneously.

Optionally, the foregoing service logic code may be, but is not limited to, a storage procedure. The storage procedure may be implemented by using various languages, for example, MySQL, Java, or the like.

The database operating apparatus provided in this example embodiment is actually a logic processing apparatus, which may be deployed alone and located between the application server and the database, or may be deployed on the application server for implementation or deployed on the database for implementation.

The database operating apparatus provided in this example embodiment obtains, according to a trigger instruction of a user, a service logic code into which a target transaction is encapsulated; speculatively executes the target transaction according to the service logic code, and speculates a segmentation condition and an involved data range of the target transaction; and controls a database to which the segmentation condition is directed to actually execute the target transaction according to the service logic code as well as the target transaction of the target transaction and the involved data range that are obtained in the process of the speculative execution, when the speculative execution succeeds. The segmentation condition of the target transaction may be obtained through speculative execution, and a database or databases on which the target transaction should be executed may be determined, ensuring the certainty of database consumption. On one hand, whether the target transaction is a stand-alone transaction or a distributed transaction is determined in advance; on the other hand, data may be prepared in advance, thus helping improve the transaction execution efficiency and further increasing the transaction throughput.

In addition, the database operating apparatus in this example embodiment combines the speculative execution and the procedure. Compared with the pure speculative execution solution, the database operating apparatus may make full use of the advantages of the procedure solution. The database may see service logic of the target transaction in the process of actual execution and execute the target transaction according to the service logic of the target transaction. Therefore, the database does not need to worry about changes in a shared data set (i.e., data in the database). Serial and correct execution of the transaction may be ensured as long as the segmentation condition and the involved data range of the target transaction do not change, which may solve the rollback phenomenon in the pure speculative execution solution to some extent, thus helping reduce the rollback probability and improve the transaction execution efficiency.

Those skilled in the art should clearly understand that to make the description convenient and concise, for specific working processes of the aforementioned system, apparatus and units, reference may be made to the corresponding processes in the foregoing method example embodiments. Details are not described here again.

In the several example embodiments provided in the present disclosure, it should be understood that the disclosed system, apparatus and method may be implemented in other manners. For example, the apparatus example embodiments described above are only exemplary. For example, division of the units is merely division based on logical functions and there may be other division manners in actual implementation. For example, a plurality of units or components may be combined or integrated into another system, or some features may be ignored or not performed. In addition, the mutual couplings or direct couplings or communication connections displayed or discussed may be implemented by using some interfaces, and the indirect couplings or communication connections between apparatuses or units may be implemented electrically, mechanically, or in another form.

The units described as separate parts may be or may not be physically separate. Parts displayed as units may be or may not be physical units, and may be located in one position or distributed on a plurality of network units. Some or all of the units may be selected according to actual needs to achieve the objectives of the solutions of the example embodiments.

In addition, functional units in the example embodiments of the present disclosure may be integrated into one processing unit, or each of the units may exist alone physically, or two or more units may be integrated into one unit. The integrated unit may be implemented in the form of hardware, or may be implemented in the form of hardware plus a software functional unit.

When the integrated unit is implemented in the form of a software functional unit, the integrated unit may be stored in a computer readable storage medium. The software functional unit is stored in a storage medium, and includes several instructions for instructing a computer device (which may be a personal computer, a server, a network device or the like) or a processor to perform all or some of the steps of the methods described in the example embodiments of the present disclosure. The foregoing storage medium includes: any medium that may store program codes, such as a USB flash drive, a removable hard disk, a Read-Only Memory (ROM), a Random Access Memory (RAM), a magnetic disk, or an optical disc.

Finally, it should be noted that the foregoing example embodiments are merely used for illustrating rather than limiting the technical solutions of the present disclosure. Although the present disclosure is described in detail with reference to the foregoing example embodiments, those of ordinary skill in the art should understand that modifications may be made to the technical solutions described in the foregoing example embodiments, or equivalent replacements may be made to some technical features. However, these modifications or replacements do not cause the essence of the corresponding technical solution to depart from the spirit and scope of the technical solutions of the example embodiments of the present disclosure.

The present disclosure may further be understood with clauses as follows.

Clause 1. A database operating method comprising:

executing a trigger instruction of a target transaction according to a user instruction to acquire a service logic code into which the target transaction is encapsulated;

conducting a speculative execution of the target transaction according to the service logic code, and recording a segmentation condition and an involved data range of the target transaction that are obtained in a process of the speculative execution; and

controlling a database to which the segmentation condition is directed to actually execute the target transaction according to the service logic code as well as the segmentation condition and the involved data range of the target transaction that are obtained in the process of the speculative execution, when the speculative execution succeeds.

Clause 2. The method of clause 1, wherein the conducting the speculative execution of the target transaction according to the service logic code comprises:

running an instruction in the service logic code; and

when the instruction is a database operating instruction in the target transaction encapsulated in the service logic code, conducting the speculative execution of the database operating instruction.

Clause 3. The method of clause 2, wherein the conducting the speculative execution of the database operating instruction comprises:

if the database operating instruction is a database modification instruction, simulating a data environment of the database operating instruction in a locally created memory library, and conducting the speculative execution of the database operating instruction based on the simulated data environment; or

if the database operating instruction is not a database modification instruction, executing the database operating instruction in the database to conduct the speculative execution of the database operating instruction.

Clause 4. The method of clause 3, wherein the simulating the data environment of the database operating instruction in the locally created memory library, and conducting the speculative execution of the database operating instruction based on the simulated data environment comprises:

splitting the database operating instruction into a read instruction and a write instruction;

executing the read instruction in the database to acquire a read data set, and storing the read data set into the memory library to simulate the data environment of the database operating instruction; and

executing the write instruction in the memory library to modify the read data set.

Clause 5. The method of any of clauses 1 to 4, wherein the controlling the database to which the segmentation condition is directed to actually execute the target transaction according to the service logic code as well as the segmentation condition and the involved data range of the target transaction that are obtained in the process of the speculative execution comprises:

issuing a name of the service logic code to the database to instruct the database to run the service logic code to actually execute the target transaction, and receiving a segmentation condition and an involved data range of the target transaction that are obtained in the process of actual execution and returned by the database;

issuing a transaction commit instruction to the database to commit the target transaction if the segmentation condition and the involved data range of the target transaction that are obtained in the process of actual execution are both the same as the segmentation condition and the involved data range of the target transaction that are obtained in the speculative execution; and

issuing a transaction rollback instruction to the database to roll back the target transaction if at least one of the segmentation condition and the involved data range of the target transaction that are obtained in the process of actual execution is different from the segmentation condition and the involved data range of the target transaction that are obtained in the speculative execution.

Clause 6. The method of any of clauses 1 to 4, wherein the controlling the database to which the segmentation condition is directed to actually execute the target transaction according to the service logic code as well as the segmentation condition and the involved data range of the target transaction that are obtained in the process of the speculative execution comprises:

issuing a name of the service logic code as well as the segmentation condition and the involved data range of the target transaction that are obtained in the process of the speculative execution to the database to instruct the database to run the service logic code to actually execute the target transaction, commit the target transaction when a segmentation condition and an involved data range of the target transaction that are obtained in the process of actual execution are both the same as the segmentation condition and the involved data range of the target transaction that are obtained in the speculative execution, or roll back the target transaction when at least one of the segmentation condition and the involved data range of the target transaction that are obtained in the process of actual execution is different from the segmentation condition and the involved data range of the target transaction that are obtained in the speculative execution.

Clause 7. The method of clause 6, wherein the issuing the name of the service logic code as well as the segmentation condition and the involved data range of the target transaction that are obtained in the process of the speculative execution to the database comprises:

issuing the name of the service logic code as well as the segmentation condition and the involved data range of the target transaction that are obtained in the process of the speculative execution to the database simultaneously.

Clause 8. The method of any of clauses 1 to 4, wherein the service logic code is a storage procedure.

Clause 9. A database operating apparatus comprising:

an acquisition module configured to execute a trigger instruction of a target transaction according to a user instruction to acquire a service logic code into which the target transaction is encapsulated;

a speculative execution module configured to conduct a speculative execution of the target transaction according to the service logic code, and record a segmentation condition and an involved data range of the target transaction that are obtained in a process of the speculative execution; and

an execution control module configured to control a database to which the segmentation condition is directed to actually execute the target transaction according to the service logic code as well as the segmentation condition and the involved data range of the target transaction that are obtained in the process of the speculative execution, when the speculative execution succeeds.

Clause 10. The apparatus of clause 9, wherein the speculative execution module is specifically configured to:

run an instruction in the service logic code; and

when the instruction is a database operating instruction in the target transaction encapsulated in the service logic code, conducting the speculative execution of the database operating instruction.

Clause 11. The apparatus of clause 10, wherein the speculative execution module is configured to:

if the database operating instruction is a database modification instruction, simulate a data environment of the database operating instruction in a locally created memory library, and conduct the speculative execution of the database operating instruction based on the simulated data environment; and

if the database operating instruction is not a database modification instruction, execute the database operating instruction in the database to conduct the speculative execution of the database operating instruction.

Clause 12. The apparatus of clause 11, wherein the speculative execution module is configured to:

split the database operating instruction into a read instruction and a write instruction;

execute the read instruction in the database to acquire a read data set, and store the read data set into the memory library to simulate the data environment of the database operating instruction; and

execute the write instruction in the memory library to modify the read data set.

Clause 13. The apparatus of any of clauses 9 to 12, wherein the execution control module is configured to:

issue a name of the service logic code to the database to instruct the database to run the service logic code to actually execute the target transaction, and receive a segmentation condition and an involved data range of the target transaction that are obtained in a process of actual execution and returned by the database;

issue a transaction commit instruction to the database to commit the target transaction if the segmentation condition and the involved data range of the target transaction that are obtained in the process of actual execution are both the same as the segmentation condition and the involved data range of the target transaction that are obtained in the speculative execution; and

issue a transaction rollback instruction to the database to roll back the target transaction if at least one of the segmentation condition and the involved data range of the target transaction that are obtained in the process of actual execution is different from the segmentation condition and the involved data range of the target transaction that are obtained in the speculative execution.

Clause 14. The apparatus of any of clauses 9 to 12, wherein the execution control module is configured to:

issue a name of the service logic code as well as the segmentation condition and the involved data range of the target transaction that are obtained in the process of the speculative execution to the database to instruct the database to run the service logic code to actually execute the target transaction, commit the target transaction when a segmentation condition and an involved data range of the target transaction that are obtained in a process of actual execution are both the same as the segmentation condition and the involved data range of the target transaction that are obtained in the speculative execution, or roll back the target transaction when at least one of the segmentation condition and the involved data range of the target transaction that are obtained in the process of actual execution is different from the segmentation condition and the involved data range of the target transaction that are obtained in the speculative execution.

Clause 15. The apparatus of clause 14, wherein the execution control module is configured to:

issue the name of the service logic code as well as the segmentation condition and the involved data range of the target transaction that are obtained in the process of the speculative execution to the database simultaneously.

Clause 16. The apparatus of any of clauses 9 to 12, wherein the service logic code is a storage procedure.

What is claimed is:

1. A method comprising:
executing a trigger instruction of a target transaction according to a user instruction to acquire a service logic code into which the target transaction is encapsulated;
conducting a speculative execution of the target transaction according to the service logic code;
recording a segmentation condition and an involved data range of the target transaction that are obtained in a process of the speculative execution;
determining that the speculative execution succeeds; and
controlling a database to which the segmentation condition is directed to conduct an actual execution of the target transaction according to the service logic code, the segmentation condition and the involved data range of the target transaction that are obtained in the process of the speculative execution.

2. The method of claim 1, wherein the conducting the speculative execution of the target transaction according to the service logic code comprises:
running an instruction in the service logic code;
determining that the instruction is a database operating instruction in the target transaction encapsulated in the service logic code; and
conducting the speculative execution of the database operating instruction.

3. The method of claim 2, wherein the conducting the speculative execution of the database operating instruction comprises:
determining that the database operating instruction is a database modification instruction;
simulating a data environment of the database operating instruction in a memory library; and
conducting the speculative execution of the database operating instruction based on the simulated data environment.

4. The method of claim 3, wherein the memory library is locally created.

5. The method of clause 3, wherein the simulating the data environment of the database operating instruction in the memory library comprises:
splitting the database operating instruction into multiple instructions including a read instruction and a write instruction;
executing the read instruction in the database to acquire a read data set; and
storing the read data set into the memory library to simulate the data environment of the database operating instruction.

6. The method of claim 5, wherein the conducting the speculative execution of the database operating instruction based on the simulated data environment comprises:
executing the write instruction in the memory library to modify the read data set.

7. The method of claim 2, wherein the conducting the speculative execution of the database operating instruction comprises:
determining that the database operating instruction is not a database modification instruction; and
executing the database operating instruction in the database to conduct the speculative execution of the database operating instruction.

8. The method of claim 1, wherein the controlling the database to which the segmentation condition is directed to conduct the actual execution of the target transaction comprises:
issuing a name of the service logic code to the database to instruct the database to run the service logic code to conduct the actual execution of the target transaction and receive a segmentation condition and an involved data range of the target transaction that are obtained in a process of actual execution and returned by the database;
determining that the segmentation condition and the involved data range of the target transaction that are obtained in the process of actual execution are the same as the segmentation condition and the involved data range of the target transaction that are obtained in the speculative execution respectively; and
issuing a transaction commit instruction to the database to commit the target transaction.

9. The method of claim 1, wherein the controlling the database to which the segmentation condition is directed to conduct the actual execution of the target transaction comprises:
issuing a name of the service logic code to the database to instruct the database to run the service logic code to conduct the actual execution of the target transaction and receive a segmentation condition and an involved data range of the target transaction that are obtained in a process of actual execution and returned by the database;
determining at least one of the segmentation condition and the involved data range of the target transaction that are obtained in the process of actual execution is different from the segmentation condition and the involved data range of the target transaction that are obtained in the speculative execution; and
issuing a transaction rollback instruction to the database to roll back the target transaction

10. The method of claim 1, wherein the controlling the database to which the segmentation condition is directed to conduct the actual execution of the target transaction comprises:
issuing a name of the service logic code, the segmentation condition and the involved data range of the target transaction that are obtained in the process of the speculative execution to the database to instruct the database to run the service logic code to conduct the actual execution of the target transaction;
determining that a segmentation condition and an involved data range of the target transaction that are obtained in a process of actual execution are the same as the segmentation condition and the involved data range of the target transaction that are obtained in the speculative execution respectively; and
committing the target transaction.

11. The method of claim 1, wherein the controlling the database to which the segmentation condition is directed to conduct the actual execution of the target transaction comprises:
issuing a name of the service logic code, the segmentation condition and the involved data range of the target transaction that are obtained in the process of the speculative execution to the database to instruct the database to run the service logic code to conduct the actual execution of the target transaction;
determining at least one of the segmentation condition and the involved data range of the target transaction that are obtained in a process of actual execution is different from the segmentation condition and the involved data range of the target transaction that are obtained in the speculative execution; and
rolling back the target transaction

12. The method of claim 11, wherein the issuing the name of the service logic code, the segmentation condition and the involved data range of the target transaction comprises:
issuing the name of the service logic code, the segmentation condition and the involved data range of the target transaction that are obtained in the process of the speculative execution to the database simultaneously.

13. The method of claim 1, wherein the service logic code is a storage procedure.

14. An apparatus comprising:
one or more processors; and
one or more memories storing thereon computer-readable instructions that, when executed by the one or more processors, cause the one or more processors to perform acts comprising:
executing a trigger instruction of a target transaction according to a user instruction to acquire a service logic code into which the target transaction is encapsulated;
conducting a speculative execution of the target transaction according to the service logic code;
recording a segmentation condition and an involved data range of the target transaction that are obtained in a process of the speculative execution;
determining that the speculative execution succeeds; and
controlling a database to which the segmentation condition is directed to conduct an actual execute the target transaction according to the service logic code, the segmentation condition and the involved data range of the target transaction that are obtained in the process of the speculative execution.

15. The apparatus of claim 14, wherein the conducting the speculative execution of the target transaction according to the service logic code comprises:
running an instruction in the service logic code;
determining that the instruction is a database operating instruction in the target transaction encapsulated in the service logic code; and
conducting the speculative execution of the database operating instruction.

16. The apparatus of claim 15, wherein the conducting the speculative execution of the database operating instruction comprises:
determining that the database operating instruction is a database modification instruction;
simulating a data environment of the database operating instruction in a locally created memory library; and
conducting the speculative execution of the database operating instruction based on the simulated data environment.

17. The apparatus of claim 16, wherein the simulating the data environment of the database operating instruction in the memory library comprises:
splitting the database operating instruction into multiple instructions including a read instruction and a write instruction;
executing the read instruction in the database to acquire a read data set; and
storing the read data set into the memory library to simulate the data environment of the database operating instruction.

18. The apparatus of claim 17, wherein the conducting the speculative execution of the database operating instruction based on the simulated data environment comprises:
executing the write instruction in the memory library to modify the read data set.

19. The apparatus of claim 15, wherein the conducting the speculative execution of the database operating instruction comprises:
determining that the database operating instruction is not a database modification instruction; and
executing the database operating instruction in the database to conduct the speculative execution of the database operating instruction.

20. One or more memories storing thereon computer-readable instructions that, when executed by one or more processors, cause the one or more processors to perform acts comprising:
executing a trigger instruction of a target transaction according to a user instruction to acquire a service logic code into which the target transaction is encapsulated;
conducting a speculative execution of the target transaction according to the service logic code;
recording a segmentation condition and an involved data range of the target transaction that are obtained in a process of the speculative execution;
determining that the speculative execution succeeds; and
controlling a database to which the segmentation condition is directed to conduct an actual execution of the target transaction according to the service logic code, the segmentation condition and the involved data range of the target transaction that are obtained in the process of the speculative execution.
